(19) United States
(12) Patent Application Publication
(10) Pub. No.: US 2025/0037591 A1
(43) Pub. Date: Jan. 30, 2025

(54) TECHNIQUES FOR PROVIDING SITUATIONAL AWARENESS

(71) Applicant: THE TEXAS A&M UNIVERSITY SYSTEM, College Station, TX (US)

(72) Inventors: Josh Boyd, College Station, TX (US); Tye Payne, College Station, TX (US); Michael J. Sanders, College Station, TX (US)

(21) Appl. No.: 18/358,846

(22) Filed: Jul. 25, 2023

(51) Int. Cl. G08G 5/00; G06T 17/05

(52) U.S. Cl. CPC G08G 5/0082; G06T 17/05; G08G 5/0069

(57) ABSTRACT

Method and systems for situational awareness are disclosed. An example method includes receiving a first set of sensor data from a plurality of internal data sources that describes geospatial locations of objects within an airspace. The method also includes receiving event data from an external data source over a network describing publicly available information affecting the airspace. The method also includes receiving a second set of sensor data from another external data source operated by a user that describes the geospatial location of a user-operated object. The method also includes generating object metadata based on the first and second sets of sensor data and the event data. The method also includes streaming at least a subset of the object metadata to the computing device of the user. The object metadata is processed to generate a real-time three-dimensional rendering of the airspace, including the objects and the user-operated object.

### TECHNICAL FIELD

Aspects and implementations of the present disclosure relate to a situational awareness system and, in particular, to system for tracking a wide variety of sensor data and event data affecting an airspace.

### BACKGROUND

Unmanned Aerial Vehicles (UAVs), sometimes referred to as drones, have come to provide a wide variety of services in an efficient, cost-effective manner. For example, UAVs have been used for applications such as disaster response, inspection of infrastructure assets (e.g., pipelines, broadcast towers, transmission lines), collection of geographic information and aerial imagery for mapping and geographical surveys, environmental monitoring, surveillance, product delivery, and many others. UAVs may be piloted remotely and may also have varying levels of autonomy. For example, UAVs may be programmed to follow pre-programmed flight paths or to select a flight path partly in response to sensor data. During flight operations, UAV operators have a responsibility to ensure that their UAVs are not interfering with national airspace and not going to cause an incident with other aircraft.

### BRIEF DESCRIPTION OF THE DRAWINGS

Embodiments and implementations of the present disclosure will be understood more fully from the detailed description given below and from the accompanying drawings of various aspects and implementations of the disclosure, which, however, should not be taken to limit the disclosure to the specific embodiments or implementations, but are for explanation and understanding only.

FIG. 1 is a block diagram that illustrates a system architecture of a situational awareness system in accordance with embodiments of the present disclosure.

FIG. 2 is a block diagram of a situational awareness application in accordance with embodiments of the present disclosure.

FIG. 3 is a process flow diagram for a method of operating a situation awareness system in accordance with embodiments of the present disclosure.

FIG. 4 illustrates a diagrammatic representation of a machine in the example form of a computer system within which a set of instructions, for causing the machine to perform any one or more of the methodologies discussed herein, may be executed.

### DETAILED DESCRIPTION

Aspects and implementations of the present disclosure are directed to techniques for implementing a situational awareness system for improving flight safety. As explained above, UAV operators have a responsibility to ensure that their UAVs are not interfering with national airspace and not going to cause an incident with other aircraft. Monitoring aircraft flight data can help to improve awareness of the potential hazards within a given airspace. However, existing systems provide limited information, which may not fully represent the conditions within an airspace. Accordingly, over-reliance on such systems may provide a false sense of safety since there may be hazards within an airspace that are not represented.

The present disclosure described an improved situational awareness system that combines a wide variety of sensor data and event data affecting an airspace. The system is configured to collect data from a variety of sources, including internal data sources operated by the service provider and external data sources operated by customers and other third-party data services. These external data sources may include UAVs, UAV simulators, radar platforms, weather data services, flight tracking systems, and others.

Telemetry and other data collected by the situational awareness system may be formatted according to a set of uniform formatting rules to generate object metadata representing all (or nearly all) of the aerial objects known to be present within a monitored volume of airspace. In some embodiments, the object metadata may also include ground objects such as building and towers, for example. The object metadata, or a subset thereof, may then be streamed to users and used to generate a three-dimensional (3D) visual display of the airspace overlayed on a 3D map of the underlying geography that shows the surface topology and may also include grounds structures such a buildings and towers. The visual display may be dynamic and interactive, enabling the user to manipulate the field of view and viewing direction to obtain a visual perspective most helpful the user. Information about each object, such as object type, object identifier, altitude, speed, Global Positioning System (GPS) coordinates, and others, may also be displayed textually or symbolically and may be toggled on or off by the user. Objects in the visual display may be represented by two-dimensional (2D) icons or 3D models. Various object types may be visually represented by a different type of 2D icon or 3D model, some or all of which may be configured to provide a sense of realism that allows to user to intuitively distinguish the various types of objects and information being displayed.

The situational awareness system may be hosted by a Web server that collects and processes the data to generate the visual display. Authorized users may access the system to provide additional data and/or receive the object metadata. The visual display may be generated at the user computing device within a Web browser or a specialized situational awareness application.

The techniques described herein improve the functioning of a computer system by providing an improved data collection infrastructure that is able collect a wide variety of data from disparate sources and process the data to provide a uniform representation that can be delivered to the computing devices of end users. This enables the situational awareness system to generate an information-rich 3D visual representation of an airspace that captures all of the aerial and ground objects that the user needs to be aware of to conduct flight operations in a safe and effective manner. The situational awareness system 100 described herein can also be used as a training tool to help pilots understand situational awareness and learn how to provide oversight over an operation.

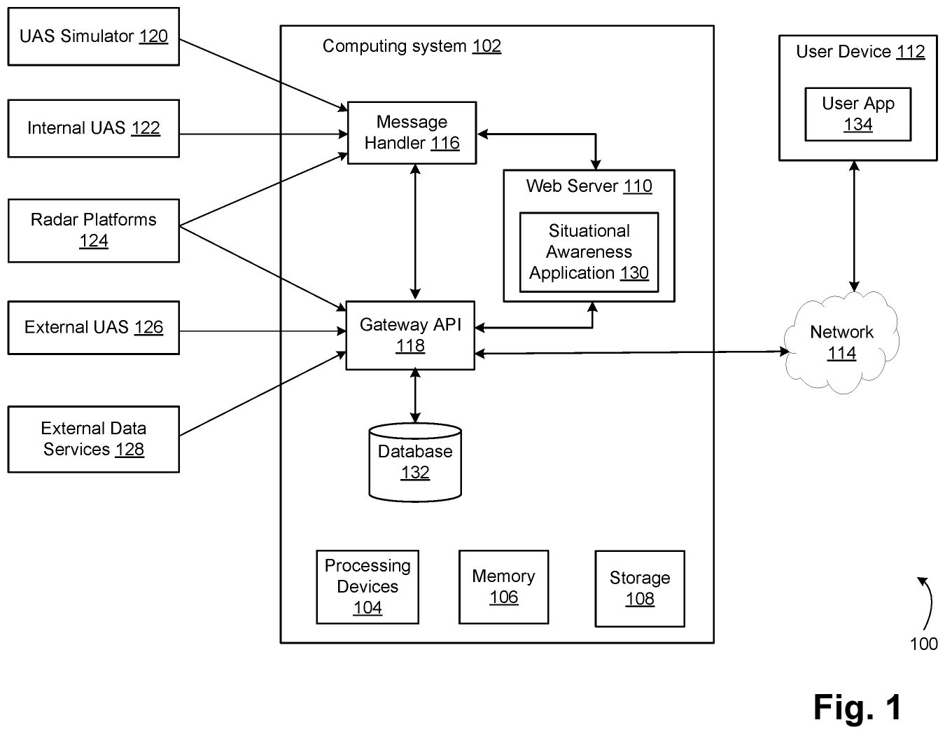

FIG. 1 is a block diagram that illustrates a system architecture of a situational awareness system in accordance with embodiments of the present disclosure. While various devices, interfaces, and logic with particular functionality are shown, it should be understood that the situational awareness system 100 can include any number of devices, components, interfaces, and logic for facilitating the functions described herein.

The situational awareness system 100 may be at least partly implemented in computing system 102 which may be a server (e.g. Web server), a collection of servers, a distributed computing cluster that serves as a cloud computing platform, and others. The computing system 102 may include processing devices 104, memory 106, and storage 108, among other components. The processing device 104 may include one or more processors of any suitable type, including complex instruction set computing (CISC) microprocessors, reduced instruction set computing (RISC) microprocessors, very long instruction word (VLIW) microprocessors, application specific integrated circuits (ASICs), field programmable gate arrays (FPGAs), digital signal processor (DSPs), and others. The memory 106 is configured as a working memory for storing programming instructions and data used by the processing devices 104 and may include volatile memory devices such as random-access memory (RAM), non-volatile memory devices such as solid-state memory. The storage 108 may be used to store long term data (e.g., user data) and to store computer programming instructions that direct the actions of the processing devices 104. Computer programming may be loaded from storage 108 into the memory 106 for execution by the processing devices 104 and may be one or more hard disk drives, solid state drives, a Redundant Array of Independent Disks (RAID) system, an array of network attached storage (NAS) devices, and others.

As shown in FIG. 1, some of the communication and computing functions of the computing system 102 are shown as a specific arrangement of software modules hosted by various components of the computing system. However, it will be appreciated that the specific embodiment shown in FIG. 1 is for convenience in describing features of the system and that the computing system 102 may be organized with any suitable structure and any suitable division or combination of programming tasks between modules and components.

The computing system 102 may include a Web server 110 that enables a user device 112 to submit requests for Web content (e.g., Web pages or other resources) via the HyperText Transfer Protocol (HTTP) and/or HTTP secure (HTTPS). The user device 112 may be any suitable electronic device (e.g., desktop computer, laptop computer, smart phone, etc.) that can access the Web server through a network 114.

The network 114 may be a public network (e.g., the internet), a private network (e.g., a local area network (LAN) or wide area network (WAN)), or a combination thereof. In one embodiment, the network 114 may include a wired or a wireless infrastructure, which may be provided by one or more wireless communications systems, such as a WiFi router connected with the network 114 and/or a wireless carrier system such as 4G or 5G that can be implemented using various data processing equipment, communication towers (e.g. cell towers), etc. In some embodiments, the network 114 may be an L3 network.

The computing system 102 may include a message handler 116 and/or a gateway Application Programming Interface (API) 118. The message handler 116 and the gateway API 118 may both include data ingestion services for receiving data from the various data sources 120-128 through a backend network. Although not explicitly depicted, it will be appreciated that the backend network may be the same as, or similar to, the network 114. Data collected from the data sources 120-128 is delivered to the situational awareness application 130 for processing.

The data sources 120-128 may include internal data sources and external data sources. Examples of internal data sources include a UAS simulator 120, internal UASs 122, and/or internal radar platforms 124. Examples of external data sources include external UAS devices 126 and external data services 128. The data services 128 may be third-party sources of publicly available information such as weather data, aircraft flight information, additional radar information, and others. Data collected through measurement by electronic devices may be collectively referred to as sensor data, and may include data such as radar data, position coordinates (latitude, longitude, altitude, etc), compass heading, battery life, air pressure, windspeed, temperature, etc. Event data may include any information or activity reported by individuals or organizations that may be relevant to an airspace, including publicly available information such as flight tracking information, current weather conditions, future weather forecasts, and others.

The data collected by the computing system 102 may be received by the message handler 116. The message handler 116 stores the received messages to a message queue and routes messages from the queue to the situational awareness application 130. The message handler 116 may be any suitable message-oriented communication infrastructure and may use a publish-subscribe mechanism for receiving data from the data sources 120-128 and routing data to the situational awareness application 130. In such embodiments, the data sources 120-128 are configured as data publishers that post messages to the message handler 116, which may also be referred to as a message broker or event bus. The message handler 116 stores the messages and then forwards the messages from storage to the subscribers, in this case the situational awareness application 130.

In some embodiments, the internal data sources operated by the provider of the situational awareness service (e.g., UAS simulator 120, internal UAS 122, radar platforms 124) may be configured to provide data directly to the message handler 116. Accordingly, each internal data source may be configured to post messages to the message handler 116. The internal data sources may also include a translator that is configured to translate the sensed data into a message format that is compatible with the message handler 116 and the situational awareness application 130.

In some embodiments, one or more external data sources (e.g., external UAS 126, external data services 128) may also be configured to provide data to computing system 102 directly to the message handler 116. However, this could involve several iterations of communication and coordination between the situation awareness service provider and the external data source to ensure that the external data source is authorized and otherwise able to publish data to the message handler 116, which could be cumbersome. To solve this problem, data from external data sources such as the external UAS 126 and external data services 128 may be received through the gateway API 118. The gateway API 118 may be configured to receive data in accordance with an API specification that may be accessed through the Web server 110 independently, i.e., without involvement of the situational awareness service provider. The API specification informs external data sources regarding any communication protocols or data formats used by the gateway API 118 for ingesting data. In this way, the gateway API 118 provides a simpler technique that enables the external data sources to provide various types of data in a format compatible with the situational awareness application 130.

Data received by the gateway API 118 from external data sources may be published to the message handler 116 and added to the data queue maintained by the message handler 116. In this way, external data received through the gateway API 118 is combined with the internal data received from internal data sources in a way that is transparent to the situation awareness application 130.

The gateway API 118 may also provide user authentication services, which may be used for authenticating external data sources and allowing them to push data to the message queue maintained by the message handler 116. The gateway API 118 may also provide user authentication services for user devices 112 to allow user devices 112 to communicate with the Web server 110 for receiving situational awareness data. To provide user authentication services, the gateway API 118 may be configured to receive user credentials (e.g., username, password, etc.) and compare those credentials against data stored to a database 132. It will be appreciated that the gateway API 118 may include additional subcomponents that are not depicted in FIG. 1. For example, the gateway API 118 may include several code modules and/or separate APIs that are coordinated to provide the functions described herein. For example, although the gateway API 118 is shown as a single component, it will be appreciated that different functions (e.g., data ingestion, user authentication) may be handled by individual APIs which are collectively referred to herein as the gateway API 118.

The internal UAS 122 refers to UAS systems operated by the service provider. The service provider may conduct UAS operations for any number of reasons, including scientific research, infrastructure inspection, security monitoring, flight training, and many others. Any number of internal UASs 122 may be communicatively coupled to the system, some or all of which may be operated independently or involved in a joint operation. The data reported by the UASs 122 may be include telemetry and volume data. Telemetry data refers to sensor data related to any of an object's measurable characteristics. For example, the telemetry data may include GPS coordinates, speed, altitude, aircraft orientation or attitude, battery life, and others. Volume data refers to a spatial volume in which an aircraft is planning to operate. The volume data may be specified by the UAS operator and may be expressed as a flight path plus buffer information that describes a volume around the flight path in which the UAS operator plans to exercise freedom of movement. The internal UAS 122 data source may also include a ground control station, which may be in communication with one or more UASs. Communications between the UAS and the ground control station may be conducted using any suitable protocol, including Micro Air Vehicle Link (MAVlink) and others. The ground control station may include a translator that translates telemetry and volume data into the messaging format used by the message handler 116.

The UAS simulator 120 generates simulated geospatial information (e.g., simulated telemetry data and/or volume data) representing a simulated object within the airspace. The UAS simulator 120 may be processing hardware or a combination of hardware and software residing on a laptop computer or other computing device. Such simulated data may be useful for conducting training exercises, testing the system's software, and testing various aspects of the system's operation and performance, for example.

The radar platforms 124 may be ground based installations that use radio waves to determine the distance (range), angle (azimuth), and radial velocity of objects relative to the site. Some radar platforms 124 may be mobile and may be moved to different geographical locations depending on coverage needs. Each radar platform 124 may include processing and communication resources that enable it to translate the radar signals into messages that contain radar data, e.g., radar imaging data, related to the location of objects detected by the radar platform 124. The radar platform 124 may also include processing and communication resources that enable it to communicate radar configuration data, such as the location coordinates of the radar platform, operating frequency, sweep frequency, alignment, and others.

As shown in FIG. 1, the radar platforms 124 are shown as being coupled to both the gateway API 118 and the message handler 116. This depiction is to underscore that any of the data sources 120-128 may be configured to communicate with message handler 116, the gateway API 118, or both. For example, one radar platform 124 may send data to the computing system 102 through the message handler 116, while another radar platform 124 may send data to the computing system 102 through the gateway API 118. Additionally, a specific radar platform 124 may be configured to send data to both the message handler 116 and the gateway API 118.

The external UAS 126 refers to UASs that are not operated by the service provider. As with the internal UAS 122, the external UAS 126 is configured to provide telemetry and volume data to the situational awareness application 130 during flight operations. The external UAS 126 may be substantially similar to the internal UAS 122 with the exception that it communicates through the gateway API 118 rather than directly through the message handler 116. Allowing external UASs 126 to provide data to the computing system 102 enables the formation of a more complete characterization of the airspace. In some cases, the external UAS operators will also be consumers of the situational awareness data provided by the situational awareness application 130 through the Web server 110. In some embodiments, external UAS operators may be requested or required to provide telemetry and/or volume data for their external UAS 126 flight operations as a condition for being able to access the situational awareness application 130.

The external data services 128 may be any service or system configured to provide additional data to the computing system 102 for improving situational awareness. The data provided by the external data services 128 may be referred to herein as event data. However, it will be appreciated that such event data may, in some cases, be ultimately derived from sensors such as radar installations, aircraft tracking sensors, and the like. In some embodiments, the external data services 128 may include a third-party service that provides flight tracking data describing geospatial locations of crewed aircraft within the airspace. For example, the external data services 128 may include an air traffic surveillance system that reports flight data such as Automatic Dependent Surveillance-Broadcast (ADS-B) data. ADS-B is a technology whereby aircraft determine their position via satellite navigation or other sensors and periodically broadcasts their position for tracking purposes. Another external data service 128 may be a Vessel Traffic Services (VTS) system that uses an Automatic Identification System (AIS) to receive data from transceivers on marine vessels in a similar manner that ADS-B is used for aircraft.

The external data services 128 may also include a third-party service that provides weather information, including current weather conditions and weather forecasts. An example of an external data services 128 that provides weather information is the national weather service. The weather data received from the national weather service may include live radar, future radar forecasts, weather alerts, current or future precipitation data, current or future wind speed, etc.

It will be appreciated that any suitable type of useful information may be provided through the external data services 128, including additional radar information, and others. The external data services 128 may include data translators that configure the data in accordance with the format specified by the gateway API 118. In some embodiments, one or more data translators may be maintained and operated by the situational awareness service provider rather that the external data services 128.

All of the various data received from the various data sources may be published by the message handler 116 to the situational awareness application 130. The situational awareness application 130 is configured to combine the received data relevant for a particular airspace into a single comprehensive 3D visual rendering, which can be delivered (e.g., streamed) to user devices 112 via the Web server 110.

In some embodiments, the data delivered to the user devices 112 may be in the form of a stream of object metadata, which may be formatted using JavaScript Object Notation (JSON). The object metadata received at the user device 112 may be visually rendered by a user application 134, which may be a Web browser, for example. The user device 112 may also include a display for displaying information and graphics to the user. In some embodiments, the display may be a touch sensitive display that can receive user input instructions through a graphical user interface, for example. The user input may be used by the user application 134 to alter the visual appearance of the displayed airspace (e.g., viewing position, viewing angle) or the type of data being displayed. In some cases, user input sent from the user device 112 to the situational awareness application 130 may be used to filter the object metadata provided to the user device 112. Although embodiments of the present technique describe streaming object metadata to the user devices 112, additional techniques may be used to deliver the visual rendering of the airspace. For example, in some embodiments, the data delivered to the user devices 112 may be in the form of an encoded video stream, which may be encoded using any suitable video file format such as H.264, H.265, and others.

Data collected by the computing system 102 may also be time stamped and stored to the database 132. In this way, the database 132 can serve as a repository of historical information that can be retrieved to provide a comprehensive view of the airspace at a specified day and time in the past. Such information may be useful for training, forensic analysis, and other applications. Historical information may also be used to generate a breadcrumb trail for aircraft, which is a graphical element that shows an aircraft's previous locations as it is being tracked.

It will be appreciated that various alterations may be made to the system 100 and that some components may be omitted or added without departing from the scope of the disclosure. For example, the specific connections between components or grouping of components may be different than what is depicted in FIG. 1.

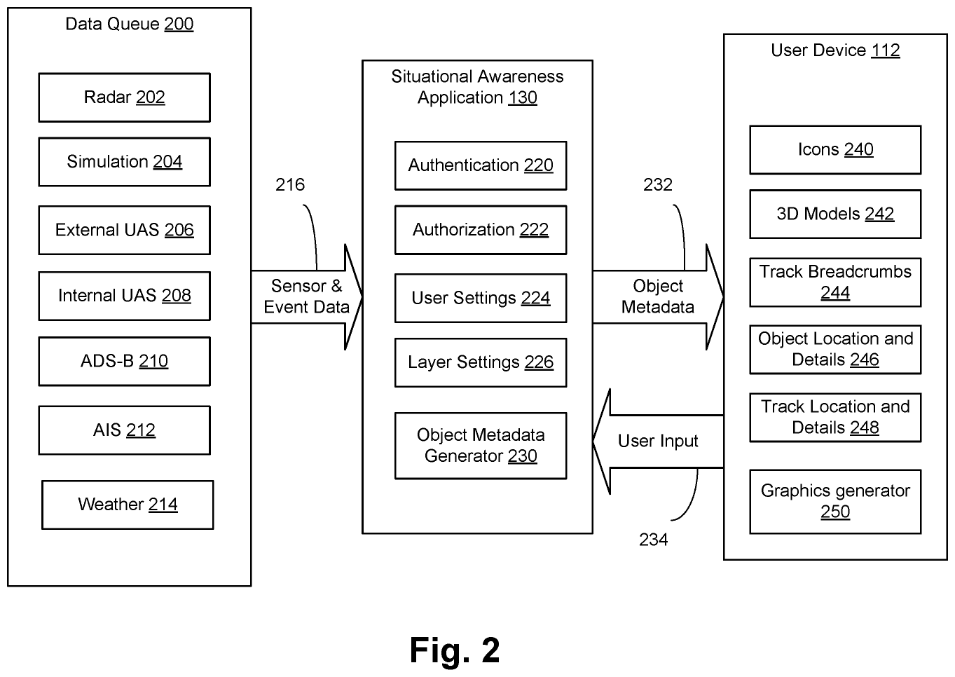

FIG. 2 is a block diagram of a situational awareness application in accordance with embodiments of the present disclosure. The situational awareness application 130 may be implemented as software operating in any suitable computing device or combination of computing devices, including the computing system 102 of FIG. 1.

As shown in FIG. 2, data consumed by the situational awareness application 130 is received through a data queue 200, which may be maintained by the message handler 116 (FIG. 1). As described above in relation to FIG. 1, the data queue 200 may receive sensor and/or event data 216 from a variety of internal and external data sources. In some embodiments, the data queue 200 may be part of a topic-based publish-subscribe system, in which case the data queue 200 may represent a single topic to which the situational awareness application 130 is a subscriber. Other arrangements are also possible. For example, each data source 120-128 (FIG. 1) may represent a different topic or each type of data may be represented as a different topic.

As described in relation to FIG. 1, the sensor and event data 216 may include radar data 202 (e.g., from radar platforms 124 and/or other data sources such as external data services 128), flight simulation data 204 (e.g., from UAS simulator 120), external UAS data 206 (from external UAS 126), and internal UAS data 208 (from internal UAS 122). The sensor and event data 216 may also include various types of data from one or more additional external data services 128, such as ADS-B data 210, AIS data 212, and weather data 214. Various other types of data may also be included in or added to the system, depending on the design considerations of a particular implementation. The sensor data represents measurements performed using electronic sensors included in the various data sources along with identifying information that identifies the source of the information. The event data may include other types of data that are not measured such as future weather forecasts, planned flight tracks, etc. Different types of sensor data and/or event data may be structured or formatted differently depending on the type of data being provided.

In some embodiments, the situational awareness application 130 includes authentication services 220 and authorization services 222 that control access to the situational awareness application 130 as described in relation to FIG. 1. Authentication and authorization may be employed differently, depending on whether the user is an internal user, such as an employee or administrator of the situational awareness service provider, or a paying customer, for example.

The situational awareness application 130 may include an object metadata generator 230 that receives the sensor and event data 216 from the data queue 200 and generates structured object metadata 232 that represents the visual objects to be included in the 3D rendering generated by the graphics generator 250. The object metadata 232 may be structured according to a consistent, unified formatting standard that applies to all visual objects. In other words, the object metadata generator 230 interprets the varying types of sensor and event data, each of which may be formatted in different ways depending on the type of information being conveyed, and generates a standardized, homogenous object representation that can be more easily processed by the graphics generator 250.

The object metadata 232 may include a plurality of objects, each of which may be structured as a set of attribute-value pairs. Each object may include one or more unique object identifiers. For example, each object may include an object identifier that uniquely identified the object with the situational awareness application 130. Some objects may also include an additional unique identifier that has real world significance, such as a Federal Aviation Administration (FAA) aircraft number, drone registration number, and others.

The object metadata 232 may also include information regarding the object type, such the type of aircraft (e.g., airplane, helicopter, drone, etc.), aircraft make and model, type of ground-based or maritime vehicle, vehicle make and model, etc. The object type may also identify the object as a stationary ground object such a radar installation (e.g., radar platform 124, or other type of infrastructure, including communication towers, building, bridges, pipelines.

The object information also includes position data (e.g., latitude, longitude, and altitude) that can be used to place the object within the visual rendering, and attitude data (e.g., compass heading, pitch, yaw, etc.) that can be used to orient the object relative to the environment. The object information can also include additional sensor information related to the status or operating conditions of the object (e.g., battery life, fuel reserves, etc.) or measurements performed by the object (e.g., speed, temperature, weather conditions, etc.)

The object metadata 232 may also identify an object as a weather-related object or event. For example, the object metadata may include a mapping of cloud cover, precipitation, windspeed, etc., which may represent current measured weather conditions or future forecast weather conditions. The object metadata 232 may also identify a planned flight track of an object and volume data that identifies a buffer zone around the planned flight path.

The object metadata 232 or a subset thereof may be sent (e.g., streamed) to the user device 112. The particular subset of object metadata may be determined at least in part based on layer settings 226, which may be used to indicate types of objects (e.g., layers) that the user wishes to view. For example, the user may want to view only aerial objects, as opposed to ground-based objects such as radar platforms, or the user may not want to view weather related data. If the user turns off a layer, the situational awareness application 130 can stop streaming object metadata related to the layer and conserve network resources.

The particular subset of object metadata to be streamed to the user may be determined at least in part based on a user selected geographical area or airspace volume. For example, the user may select a particular geographical area and/or range of altitudes as a region of interest. If a region of interest is selected, the situational awareness application 130 can stop streaming objects that are not located within the selected region of interest. The user settings 224 may be a set of stored parameters that represent user preferences and/or a previous settings selected by the user as it relates to factors such as layer settings 226, region of interest, viewing position and angle, etc.

The user device 112 may maintain a persistent duplex connection to the Web server, for example, by holding two HTTP connections open at the same time. This enables the situational awareness application 130 to stream data to the user device 112 while also receiving user input 234. This allows the user to manipulate the visual rendering by changing region of interest, the viewing position and viewing angle, turning layers on or off, etc.

The user device 112 may include a graphics generator 250 that generates the 3D visual rendering based on the object metadata and other data such as the user's selected viewing position and viewing angle, for example. The graphics generator 250 may be implemented in a Web browser and may include programming downloaded from the Web server 110 (FIG. 1) such as Java script programs and/or libraries.

In some embodiments, icons 240 and models 242 may be received from the situational awareness application 130. Icons 240 and models 242 may be used as markers for the displayed objects and may be customized based on object type. Icons 240 may be 2D object image or symbol that can that be specified for certain object types. The 3D models 242 provide a more realistic 3D image that can be oriented within the visual rendering to represent the orientation (e.g., heading, etc.) of an object and to provide a more intuitive, information-rich representation of objects, especially aerial objects.

The object metadata 232 sent to the user device 112 may include object location and details 246 and track location and details 248. The object location and details 246 describes objects to be added to the display and may include aerial objects such as UAVs and ground objects such as radar installations. The objects may be associated with an icon 204 or a 3D model 242 that the graphics generator 250 uses to represent the objects. The track location and details 248 describes flight track and volume information to be added to the display. The track location and details 248 may be related to information received from particular objects (e.g., a specific UAV or other aircraft) or from a flight tracking service such as ADS-B 210 or AIS 212.

The user device 112 may also maintain a continuous record of the object locations that it receives during a user session. Previous object locations may be displayed as track breadcrumbs 244 that trail behind the object's current location.

During a user session, the user can interact with the display generated by the graphics generator to change the informational content. For example, the user can change the airspace volume to be displayed by selecting a particular geographical area within the display and/or choose the specific types of information (e.g., layers) to be displayed. Some user selections may generate user input 234 that is sent to the situational awareness application 130, which processes the user input to determine the object metadata 232 to be sent to the user device 112. In some cases, the user input 234 may result in the situation awareness application 130 sending a subset of the available object metadata. For example, if the user input indicates that the user does not want to display weather data 214, the situational awareness application 130 can stop streaming weather-related object metadata to the user device 112.

Some user interactions may generate user input that is processed by the graphics generator without being sent to the situational awareness application 130. For example, the user can change the viewing position and/or angle by, for example, clicking and dragging on the display and/or entering specific viewing angle and positions coordinates (latitude, longitude, and altitude). The graphics generator 250 can render the object metadata in accordance with the user's selections. Additionally, the user may also select a specific object to obtain additional information about that object. For example, if the user clicks on one of the displayed icons or 3D models, the graphics generator 250 may generate a pop-up box that provides a listing of the object metadata pertaining to that object, such as object identifiers, object type, position coordinates, and the like.

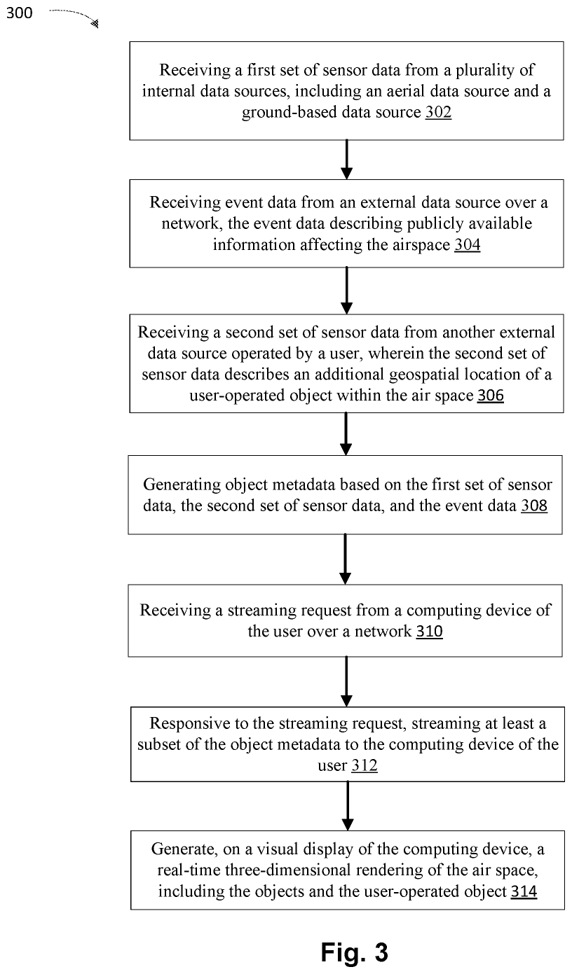

FIG. 3 is a process flow diagram for a method of operating a situation awareness system in accordance with embodiments of the present disclosure. The method 300 may be performed by any suitable combination of processing logic, which may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), etc. In some embodiments, the method 300 may be performed by the situation awareness application 130 which may reside on the computing system 102 shown in FIG. 1. The method may begin at block 302.

At block 302, a first set of sensor data is received from a plurality of internal data sources. The first set of sensor data describes geospatial locations (e.g., latitude, longitude, altitude) of objects within an airspace and can also include other telemetry and volume data for the objects. The plurality of internal data sources may include at least one aerial data source coupled to at least one of the objects within the airspace and configured to report its own geospatial location. The plurality of internal data sources may also include at least one ground-based data source that uses radar to remotely detect the objects within the airspace. The first set of sensor data may be received through the message handler 116.

At block 304, event data is received from an external data source over a network. The event data describes publicly available information affecting the airspace, such as aircraft tracking data and flight plans (e.g., ADS-B data), weather information, and others. The external data source may be an external data services 128 that provides data through the gateway API 128.

At block 306, a second set of sensor data is received from another external data source operated by a user, wherein the second set of sensor data describes an additional geospatial location of a user-operated object within the airspace. For example, the second set of sensor data may describe the geospatial location a UAV or other aircraft operated by a subscriber to the situational awareness system. The second set of sensor data may be received through the gateway API 118 and can also include other telemetry and volume data for the user-operated object.

At block 308, object metadata is generated based on the first set of sensor data, the second set of sensor data, and the event data. The object metadata data may include a plurality of object representations, each of which may be a structured data object. For example, each data object may be structured as a plurality of key-value pairs that describe the properties a particular object or event effecting the airspace.

At block 310, a streaming request is received from a computing device of the user over a network. The streaming request may be received by a Web server through an API, such as the gateway API 218. The streaming request may include a description of a geographical area to be monitored, in which case, the object metadata may be filtered to the subset of the object metadata that affects the geographical area. The streaming request may be received from the operator of the user-operated object described in relation to block 306. However, it will be appreciated that subscribers to the situational awareness service may use the service without providing sensor data to the system.

At block 312, at least a subset of the object metadata is streamed to the computing device of the user responsive to the streaming request. The subset of object metadata may be filtered out of the full set of available object metadata based on user input, such as a description of the region of interest or a description of particular object types (e.g., layers) of interest.

At block 314, the subset of the object metadata is processed to generate, on a visual display of the computing device, a real-time 3D rendering of the airspace, including the objects and the user-operated object. In some embodiments, the processing is performed by the browser that resides on the user's computing device in accordance with programming (e.g., Javascript) provided by the situational awareness system.

It will be appreciated that embodiments of the method 300 may include additional blocks not shown in FIG. 3 and that some of the blocks shown in FIG. 3 may be omitted. Additionally, the processes associated with blocks 302 through 314 may be performed in a different order than what is shown in FIG. 3.

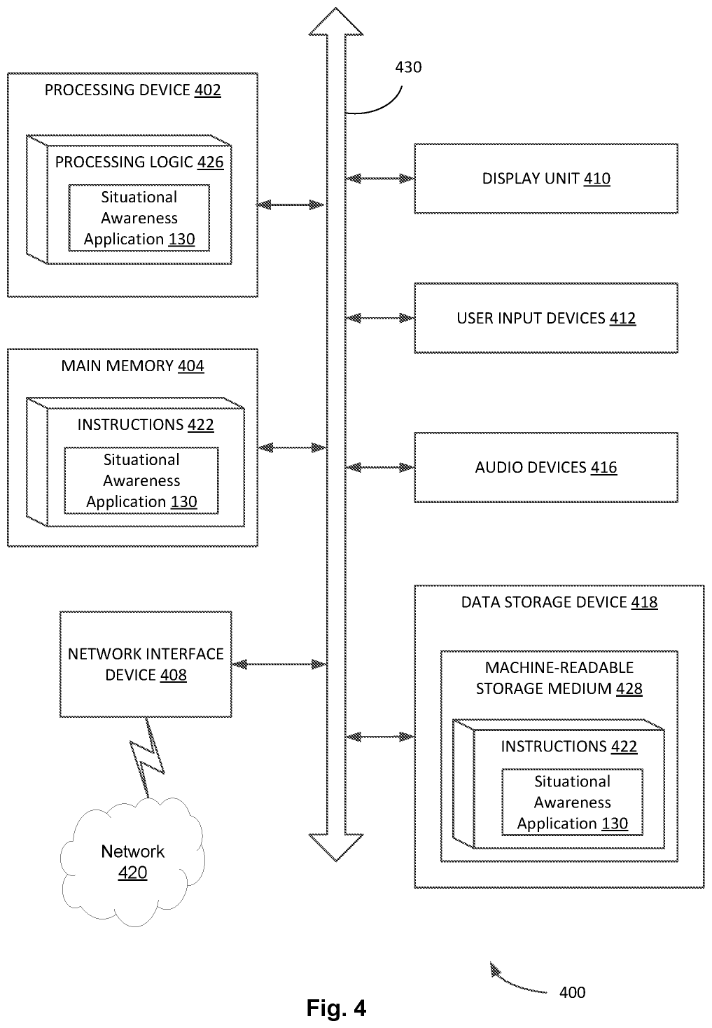

FIG. 4 illustrates a diagrammatic representation of a machine in the example form of a computer system 400 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a Personal Computer (PC), a tablet PC, a web appliance, a server, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 400 may be representative of a server configured to control the operations of a situation awareness system 100 (FIG. 1).

The example computer system 400 includes a processing device 402, a user interface display 413, a main memory 404 (e.g., read-only memory (ROM), flash memory, dynamic random access memory (DRAM), a static memory 406 (e.g., flash memory, static random access memory (SRAM), etc.), and a data storage device 418, which communicate with each other via a bus 430. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 402 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 402 may also be one or more special-purpose processing devices such as an application specific integrated circuit (ASIC), a field programmable gate array (FPGA), a digital signal processor (DSP), network processor, or the like. The processing device 402 is configured to execute processing logic 426 for performing the operations of a situational awareness application 130 as discussed herein.

The data storage device 418 may include a non-transitory machine-readable storage medium 428, on which is stored one or more set of instructions 422 (e.g., software) embodying any one or more of the processes described herein, including processes performed by the situational awareness application 130. The instructions 422 may also reside, completely or at least partially, within the main memory 404 or within the processing device 402 during execution thereof by the computer system 400, the main memory 404 and the processing device 402 also constituting machine-readable storage media. The instructions 422 may further be transmitted or received over a network 420 via the network interface device 408.

While the machine-readable storage medium 428 is shown as an example embodiment of a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely example embodiments. Variations and modifications will occur to those skilled in the art, and all such variations and modifications are considered to be part of the disclosure, as defined in the claims.

Additionally, some embodiments may be practiced in distributed computing environments where the machine-readable medium is stored on and or executed by more than one computer system. In addition, the information transferred between computer systems may either be pulled or pushed across the communication medium connecting the computer systems.

Embodiments of the claimed subject matter include, but are not limited to, various operations described herein. These operations may be performed by hardware components, software, firmware, or a combination thereof. Although the operations of the methods herein are shown and described in a particular order, the order of the operations of each method may be altered so that certain operations may be performed in a different order or so that certain operation may be performed, at least in part, concurrently with other operations. In another embodiment, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. Any aspect or design described herein as an example is not necessarily to be construed as preferred or advantageous over other aspects or designs. Rather, use of the word “example” is intended to present concepts in a concrete fashion. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. A method of operating a situational awareness system, comprising:
receiving a first set of sensor data from a plurality of internal data sources, wherein the first set of sensor data describes geospatial locations of objects within an airspace, and wherein the plurality of internal data sources comprises: an aerial data source coupled to at least one of the objects within the airspace and configured to report its own geospatial location; and a ground-based data source that uses radar to remotely detect the objects within the airspace;
receiving event data from an external data source over a network, the event data describing publicly available information affecting the airspace;
receiving a second set of sensor data from another external data source operated by a user, wherein the second set of sensor data describes an additional geospatial location of a user-operated object within the airspace;
generating object metadata based on the first set of sensor data, the second set of sensor data, and the event data;
receiving a streaming request from a computing device of the user over a network; and
responsive to the streaming request, streaming at least a subset of the object metadata to the computing device of the user;
wherein the subset of the object metadata is processed to generate, on a visual display of the computing device, a real-time three-dimensional rendering of the airspace, including the objects and the user-operated object.

2. The method of claim 1, wherein the first set of sensor data is received from the plurality of internal data sources over a private network.

3. The method of claim 1, wherein the event data and the second set of sensor data is received through an Application Programming Interface (API).

4. The method of claim 1, wherein the streaming request includes a description of a geographical area, the method comprising filtering the object metadata to the subset of the object metadata that affects the geographical area.

5. The method of claim 1, wherein the external data source is a weather service, and the event data comprises a mapping of current weather conditions.

6. The method of claim 1, wherein the external data source is an air traffic surveillance system, and the event data comprises flight tracking information describing geospatial locations of crewed aircraft within the airspace.

7. The method of claim 1, wherein the plurality of internal data sources includes a simulator configured to generate simulated geospatial information representing a simulated object within the airspace.

8. A computing system, comprising:
a memory; and
a processing device operatively coupled to the memory, the processing device to:
receive a first set of sensor data from a plurality of internal data sources, wherein the first set of sensor data describes geospatial locations of objects within an airspace, and wherein the plurality of internal data sources comprises: an aerial data source coupled to at least one of the objects within the airspace and configured to report its own geospatial location; and a ground-based data source that uses radar to remotely detect the objects within the airspace;
receive event data from an external data source over a network, the event data describing publicly available information affecting the airspace;
receive a second set of sensor data from another external data source operated by a user, wherein the second set of sensor data describes an additional geospatial location of a user-operated object within the airspace;
generate object metadata based on the first set of sensor data, the second set of sensor data, and the event data;
receive a streaming request from a computing device of the user over a network; and
responsive to the streaming request, stream at least a subset of the object metadata to the computing device of the user;
wherein the subset of the object metadata is processed to generate, on a visual display of the computing device, a real-time three-dimensional rendering of the airspace, including the objects and the user-operated object.

9. The computing system of claim 8, wherein the first set of sensor data is received from the plurality of internal data sources over a private network.

10. The computing system of claim 8, wherein the event data and the second set of sensor data is received through an Application Programming Interface (API).

11. The computing system of claim 8, wherein the streaming request includes a description of a geographical area, and the processing device is to filter the object metadata to the subset of the object metadata that affects the geographical area.

12. The computing system of claim 8, wherein the external data source is a weather service, and the event data comprises a mapping of current weather conditions.

13. The computing system of claim 8, wherein the external data source is an air traffic surveillance system, and the event data comprises flight tracking information describing geospatial locations of crewed aircraft within the airspace.

14. The computing system of claim 8, wherein the plurality of internal data sources includes a simulator configured to generate simulated geospatial information representing a simulated object within the airspace.

15. A non-transitory computer-readable storage medium comprising instructions that, when executed by a processing device, cause the processing device to:
receive a first set of sensor data from a plurality of internal data sources, wherein the first set of sensor data describes geospatial locations of objects within an airspace, and wherein the plurality of internal data sources comprises: an aerial data source coupled to at least one of the objects within the airspace and configured to report its own geospatial location; and a ground-based data source that uses radar to remotely detect the objects within the airspace;
receive event data from an external data source over a network, the event data describing publicly available information affecting the airspace;
receive a second set of sensor data from another external data source operated by a user, wherein the second set of sensor data describes an additional geospatial location of a user-operated object within the airspace;
generate object metadata based on the first set of sensor data, the second set of sensor data, and the event data;
receive a streaming request from a computing device of the user over a network; and
responsive to the streaming request, stream at least a subset of the object metadata to the computing device of the user;
wherein the subset of the object metadata is processed to generate, on a visual display of the computing device, a real-time three-dimensional rendering of the airspace, including the objects and the user-operated object.

16. The non-transitory computer-readable storage medium of claim 15, wherein the first set of sensor data is received from the plurality of internal data sources over a private network.

17. The non-transitory computer-readable storage medium of claim 15, wherein the event data and the second set of sensor data is received through an Application Programming Interface (API).

18. The non-transitory computer-readable storage medium of claim 15, wherein the streaming request includes a description of a geographical area, and the instructions further cause the processing device to filter the object metadata to the subset of the object metadata that affects the geographical area.

19. The non-transitory computer-readable storage medium of claim 15, wherein the external data source is a weather service, and the event data comprises a mapping of current weather conditions.

20. The non-transitory computer-readable storage medium of claim 15, wherein the external data source is an air traffic surveillance system, and the event data comprises flight tracking information describing geospatial locations of crewed aircraft within the airspace.
